(19) United States
(12) Patent Application Publication
(10) Pub. No.: US 2026/0314514 A1
(43) Pub. Date: Oct. 15, 2026

(54) ROD ASSEMBLY FOR A TRAILER SYSTEM, IN PARTICULAR AN AGRICULTURAL MACHINE

(71) Applicant: JOST-Werke Deutschland GmbH, Neu-Isenburg (DE)

(72) Inventors: Joakim Alaspää, Jyväskylä (FI); Timo Viikki, Kuusa (FI)

(21) Appl. No.: 19/444,652

(22) Filed: Jan. 9, 2026

(30) Foreign Application Priority Data
Jan. 15, 2025 (DE) 10 2025 101 246.6
Jun. 24, 2025 (DE) 10 2025 124 408.1

(51) Int. Cl. A01B 59/00; A01B 59/06

(52) U.S. Cl. CPC A01B 59/004; A01B 59/066

(57) ABSTRACT

A rod assembly for a trailer system having a first rod extending along a first longitudinal axis with an inhibiting counter-formation and a second rod extending along a second longitudinal axis which are connected through a coupling arrangement, where the second rod is displaceable along the first longitudinal axis between a lower position and an upper position, where the coupling arrangement exhibits a first coupling formation and a second coupling formation with an inhibiting formation, where the second coupling formation can be brought relative to the first rod into a third operating position different from a first and a second operating position, in which the inhibiting formation with the inhibiting counter-formation inhibits a movement of the second rod relative to the first rod from the upper position towards the lower position, one formation out of inhibiting formation and inhibiting counter-formation exhibits a latching projection and the respective other formation exhibits a latching recess, where in the third operating position the inhibiting formation and the inhibiting counter-formation are, disengageable against a pre-tensioning, in an overcomeable latching engagement.

This Application claims priority in German Patent Application DE 10 2025 101 246.6 filed on Jan. 15, 2025 and German Patent Application DE 10 2025 124 408.1 filed on Jun. 24, 2025, which are incorporated by reference herein.

The present application concerns a rod assembly for a trailer system. Here the thinking is in particular about a trailer system for agricultural machines, such as e.g. tractors, agricultural tractor units, and the like. One preferred trailer system is a three-point hitch. This is also referred to in relevant professional circles as ‘three-point linkage’ or ‘three-point power lift’or ‘three-point hydraulics’.

The rod assembly comprises a first rod extending along a virtual first longitudinal axis and a second rod extending along a virtual second longitudinal axis. The first and the second rod are connected through a coupling arrangement. The first and the second longitudinal axis enclose an angle. The second rod is displaceable relative to the first rod at the point of its coupling with the first rod along the first longitudinal axis between a longitudinal end-proximal position lying nearer to a longitudinal end of the first rod and a longitudinal end-distal position lying further away from the longitudinal end.

The coupling arrangement exhibits a first coupling formation and a second coupling formation. The first coupling formation is arranged at the first rod. The second coupling formation is arranged at the second rod moveably both relative to the first rod and relative to the second rod.

The second coupling formation exhibits an abutment formation and an inhibiting formation. The first rod exhibits an abutment counter-formation and an inhibiting counter-formation.

The second coupling formation can be brought relative to the first rod into a first operating position which is assigned to a first configuration of the rod assembly in which the abutment formation abuts against the abutment counter-formation and thereby inhibits a movement of the second rod relative to the first rod from the longitudinal end-proximal position towards the longitudinal end-distal position.

The second coupling formation can be brought relative to the first rod into a second operating position different from the first operating position, in which a movement of the second rod relative to the first rod along the first longitudinal axis is allowed. The second operating position of the second coupling formation is thus assigned to a second configuration of the rod assembly.

The second coupling formation can be brought relative to the first rod into a third operating position different from the first and the second operating position, which is assigned to a third configuration of the rod assembly in which the inhibiting formation interacts with the inhibiting counter-formation and thereby inhibits a movement of the second rod relative to the first rod from the longitudinal end-distal position towards the longitudinal end-proximal position.

### BACKGROUND OF THE INVENTION

Such a rod assembly as part of a three-point hitch of an agricultural tractor unit is known from EP 4 085 739 A1. The second coupling formation configured there as a plate-shaped component arrangement and comprising one plate component referred to as ‘ending plate’ and one as ‘fixing plate’ exhibits parallel lateral edges as abutment formation and exhibits on both sides protrusions, each projecting over the lateral edges, as inhibiting formation. It is fixed rotatably to the second rod. The two plate components which are configured essentially identically hold between them the first coupling formation and the second rod. The plate components are connected with one another by means of a cylindrical connecting shaft. The shaft defines the axis of rotation about which the known second coupling formation can rotate.

The second rod is in EP 4 085 739 A1, just as it is also preferably for the present rod assembly, a lower link of a three-point hitch of a tractor or generally of an agricultural tractor unit.

The first rod is referred to in EP 4 085 739 A1 as ‘lifting rod’ and forms, just as it is also preferably for the present rod assembly, a lifting rod of the three-point hitch which connects the lower link with a lifting arm of the three-point hitch.

The first coupling formation known from EP 4 085 739 A1 exhibits in each branch of a longitudinal end-side fork section of the first rod a penetrating hole running along the first longitudinal axis and two rail-like projections configured integrally with the fork section of the first rod and parallel both to one another and to the first longitudinal axis. The remarks in this paragraph describe not only the state of the art, but also a preferred configuration of the rod assembly of the present application.

The penetrating holes of the two branches of the fork section and a complementary penetrating hole penetrating through the second rod are penetrated by the connecting shaft of the second coupling formation. A material of the fork limbs of the first rod surrounding the two penetrating holes is thus engaged from behind by the second coupling formation, more precisely by its plate components. The second coupling formation is in this manner arranged at the second rod and through rotation about the shaft axis of the connecting shaft adjustable between the aforementioned operating positions. The remarks in this paragraph likewise describe not only the state of the art, but also a preferred configuration of the rod assembly of the present application.

The longitudinal-end proximal longitudinal ends of the rail-like projections form the abutment counter-formation. The opposite longitudinal end-distal longitudinal ends of the rail-like projections form the inhibiting counter-formation and the flanks of the rail-like projections facing towards one another are in the second operating position in sliding abutment engagement with the lateral edges of the second coupling formation in order to guide a movement of the second coupling formation and with it a translatory movement of the second rod along the first longitudinal axis. The two rail-like projections thus form a groove running along the first longitudinal axis in which the second coupling formation can in the second operating position slide along the first longitudinal axis. Accordingly, the lateral edges of the second coupling formation are also parallel in their second operating position both to one another and also to the first longitudinal axis. The remarks in this paragraph describe not only the state of the art, but also a preferred configuration of the rod assembly of the present application.

Through the choice of the length of the penetrating hole and through the positioning of the penetrating hole at the first rod relative to the longitudinal ends of the rail-like projections forming the abutment counter-formation, when the second coupling formation is in its first operating position the coupling arrangement connects the second rod with the first rod along the first longitudinal axis essentially backlash-free. The longitudinal end of the penetrating hole nearest to the nearest longitudinal end of the first rod abuts physically against the connecting shaft penetrating it and the abutment formation abuts against the abutment counter-formation. The aforementioned abutment points of connecting shaft and longitudinal end of the penetrating hole on the one hand and of abutment formation and abutment counter-formation on the other lie on different sides of the axis of rotation defined by the connecting shaft and thus allow essentially backlash-free clamping of the second coupling formation by the first rod and the second rod along the first longitudinal axis. The remarks in this paragraph describe not only the state of the art, but also a preferred configuration of the rod assembly of the present application.

The first operating position is an operating position in which the lower link and/or the second rod respectively is at a fixed lowest position relative to the lifting rod and/or first rod respectively which in proper operation runs predominantly vertically. The first operating position of the second coupling formation is thus assigned to the aforementioned first configuration of the rod assembly. In this fixed lowest position, the vertical position of a work tool mounted on the three-point hitch is accurately adjustable through a lifting actuator. Such accurate vertical positioning is required for example for ploughs. The remarks in this paragraph describe not only the state of the art, but also a preferred configuration of the rod assembly of the present application.

The second operating position is a floating position, in which the second rod is moveable along the first longitudinal axis relative to the first rod to a predetermined extent, for instance predetermined by the length of the penetrating hole. Incidentally, ‘lengthwise to a longitudinal axis’ or ‘along a longitudinal axis’ do not mean, within the terms of the present application, obligatory parallelism to the longitudinal axis, although this is preferred. A movement is already ‘lengthwise to a longitudinal axis’ or ‘along a longitudinal axis’ when the movement exhibits an axial movement component lengthwise to or along the longitudinal axis, where preferably the axial movement component is the largest movement component in absolute terms compared to two movement components which are orthogonal to one another and to the axial movement component. The second operating position of the second coupling formation is thus assigned to the aforementioned second configuration of the rod assembly.

The floating position is an operating position which is needed for example for agricultural work tools which should follow a terrain surface, such as for example a roller or some harrows. The remarks in this paragraph describe not only the state of the art, but likewise a preferred configuration of the rod assembly of the present application.

When the second coupling formation is in its third operating position, the second rod is in a top operating position relative to the first rod. The third operating position of the second coupling formation is thus assigned to the aforementioned third configuration of the rod assembly. In analogy with the first operating position, the second rod is fixed relative to the first rod along the first longitudinal axis essentially backlash-free through dimensioning and positioning of the penetrating hole in the respective branches of the fork section of the first rod. The remarks in this paragraph describe not only the state of the art, but likewise a preferred configuration of the rod assembly of the present application.

This top operating position is chosen, for example, when no load is attached to the trailer system, for instance if a towing vehicle carrying the trailer system has to maneuver and collisions of the trailer system with objects near the ground are to be avoided. In the second operating position, the lateral protrusions which project over the lateral edges of the plate components of the second coupling formation in accordance with EP 4 085 739 A1 rest on the longitudinal ends of the rail-like projections which in the operational arrangement are the top ones lying distally to the nearest longitudinal end of the first rod.

If now, due to negligence, a load is attached to the trailer system while the second rod is in its top operating position and the second coupling formation is in its third operating position, the force acting on the protrusions of the second coupling formation due to the attached load can exceed the strength limits of the protrusions of the second coupling formation, thus destroying the second coupling formation through fracture or plastic deformation.

### SUMMARY OF THE INVENTION

It is the task of the present invention to at least minimize the risk of inadvertent destruction of the second coupling formation, and thereby of the rod assembly overall, when the second coupling formation is in the third operating position.

The present invention solves this task in a rod assembly of the type mentioned at the beginning by having one formation out of inhibiting formation and inhibiting counter-formation exhibit a latching projection and the respective other formation out of inhibiting formation and inhibiting counter-formation exhibit a latching recess, where in the third operating position the inhibiting formation and the inhibiting counter-formation are, disengageable against a pre-tensioning, in an overcomeable latching engagement. A latching engagement is here a positive locking engagement in which the latching projection projects into the latching recess.

The overcomeable latching engagement is based on the one hand on a pre-tensioning force which effects and/or secures the latching engagement, with which at least one structure out of latching projection and latching recess in latching engagement counteracts removal from the latching engagement, and on the other hand on the shape of latching projection and latching recess. The shape of the latching projection and latching recess in the latching engagement effects that and in what ratio an external force acting from outside along the first longitudinal axis from the longitudinal end-distal position towards the longitudinal end-proximal position is translated into a force component opposite to the securing pre-tensioning force. Thus, through the shape of latching projection and latching recess and through the magnitude of the securing pre-tensioning force, the limiting load can be adjusted starting from which the external force acting from outside on the rod assembly, in particular on the second rod, disengages the overcomeable latching engagement of latching projection and latching recess. Indeed, a relative movement of the first and second rod relative to one another begins on overcoming the latching engagement, but destruction of the rod assembly or its disablement through deformation is avoided. Deformation of the latching projection and/or of the latching recess during the overcoming is essentially solely elastically reversible.

The relative movement which begins on overcoming the latching engagement and thereby giving up the relative position of the first and second rod which to begin with was secured by the third operating position is readily acceptable, since the third operating position of the second coupling formation is normally selected when the rod assembly is and/or should be, respectively, free from external loads.

If, in the third operating position, external loads are applied to the rod assembly, normally prior to that the third operating position would have had to be changed into the first or the second operating position or the application of external loads should not have been allowed to occur. Thus the overcoming of the latching engagement in the third operating position of the second coupling formation remains normally without adverse consequences. It is only necessary to establish an operating position out of the first, the second, or the third operating position.

In principle, the latching recess can be so adequately configured displaceable and/or elastically deformable against spring pre-tensioning that when overcoming the established latching engagement the latching recess draws back under the effect of an adequately large external force and releases the latching projection from the latching engagement. Alternatively or additionally, the latching projection can be configured displaceable and/or elastically deformable against spring pre-tensioning, such that under the effect of an adequately large external force it draws back out of the latching recess and escapes from the latter.

According to an embodiment which can be realized at advantageously low cost and therefore is preferable, the latching projection, preferably only the latching projection, is a latching projection which is deformable against its component elasticity between a latching engagement shape and an out of engagement shape. The latching recess is preferably rigid compared with the latching projection, such that overcoming an latching engagement established between latching projection and latching recess preferably takes place only through displacement and/or deformation of the latching projection. Since in the latching engagement the latching recess surrounds the latching projection, normally the installation or movement space of the latching projection required for overcoming the latching engagement is smaller than the space of a displacement and/or deformation of the latching recess needed for the same purpose. The component elasticity of the latching projection is determined by the shape of the latching projection and the material elasticity of the at least one material used to produce the latching projection.

The latching projection is preferably configured as a spring. Then through the spring shape and spring hardness and the installation situation of the latching projection, it is possible simply and accurately to set a limiting load acting from outside on the rod assembly at the exceeding of which the latching projection is so strongly deformed that it leaves the latching engagement with the latching recess. The latching projection can formed from a wire as a wire spring, such that through the wire cross-section and the spring form arbitrarily high stiffness and thus deformation and/or displacement resistances can be realized.

According to a preferred embodiment of the present invention, the latching projection can be implemented as a spring in the shape of a spring pin or comprise a spring pin. A spring pin, in professional circles also referred to as ‘clamping sleeve’, is a widespread commercially available mechanical element, which therefore can be obtained inexpensively. The spring pin is a tube-shaped hollow component running along a pin axis, which owes its spring property to a slit running along, preferably parallel to, the pin axis.

A spring pin used as a latching projection is preferably a spring pin fabricated in accordance with an industry standard such as e.g. EN ISO 8750, EN ISO 8751, EN ISO 8752, or EN ISO 13337, in particular a cylindrical spring pin. Standardized spring pins can be obtained at low cost in large numbers with essentially identical component properties.

A latching recess interacting in particular with the spring pin as latching projection can preferably be configured as a latching mouth. The preferred latching mouth exhibits a mouth entrance with a narrower clear width and a mouth accommodating space with a wider clear width. The latching projection can arrive through the mouth entrance into the mouth accommodating space through temporary deformation of itself. Establishing the latching engagement takes place through a relative movement of latching projection and latching recess along an insertion path, in consequence of the which latching projection, in particular in the shape of a spring pin, arrives through the mouth entrance into the mouth accommodating space. The aforementioned clear widths should therefore be measured orthogonally to the insertion path. The insertion path preferably proceeds along, especially preferably in parallel to, the first longitudinal axis.

The force needed for establishing and for overcoming the latching engagement can be adjusted through the choice of the material and dimensions, such as for instance wall thickness and outer diameter, of the spring pin preferred as latching projection, and through the difference between the clear width of the mouth entrance and the outer dimensions of the spring pin to be measured in the same direction.

In principle it is also possible, additionally or alternatively, to conceive of configuring the mouth entrance-forming flanks of the latching recess configured as latching mouth elastically sprung in the direction towards one another and/or away from one another.

An advantageously lower surface pressure between the latching projection and a component abutting against the latching projection, such as in particular the latching recess, can be achieved by the latching projection at least section-wise comprising a flat spring or being formed as a flat spring. A flat spring is made from a spring material whose thickness is considerably smaller than its width and even further considerably smaller than its length. Preferably the thickness of the spring material is not more than a third of the width of the spring material, especially preferably not more than a fifth. Familiar flat springs are for example leaf springs. Especially preferably, the latching projection is a flat spring. The latter can be clamped to a spring carrier on one side and project from a spring carrier on one side.

Abrasion situations between the latching projection and a surface along which the latching projection slides during operation can be avoided by the latching projection comprising a curved flat spring or preferably being a curved flat spring. In order to avoid undesirable tilting moments at the coupling arrangement during the establishing and/or the overcoming of a latching engagement of the latching projection, the latching projection is preferably a mirror-symmetrical component. As such, the latching projection comprises or is a flat spring, preferably curved, clamped at both sides to a spring carrier. The aforementioned elastically deformable spring pin too, is preferably a mirror-symmetrical component. The pin axis lies preferably in the symmetry plane of the spring pin, likewise its longitudinal slit.

The mirror-symmetry plane of the preferably mirror-symmetrical latching projection proceeds when viewed in the third operating situation preferably in parallel to the first longitudinal axis or contains the latter. Thereby, the latching engagement can in the event of external impact of a force acting along the first longitudinal axis be overcome moment-free with only negligible torque effects.

In principle, the first coupling formation can exhibit the latching projection. This is for example preferably the case when the latching projection is configured through the aforementioned spring pin. In this preferred embodiment, the second coupling formation can exhibit the latching recess, in particular in the shape of the latching mouth described above. The first rod then preferably carries the latching projection, in particular in the shape of a spring pin.

In an advantageous development of the invention, the second coupling formation can, for facilitated establishment of the latching engagement, exhibit the latching recess at a component edge leading along the first longitudinal axis for establishing the third configuration of the rod assembly. From the component edge, the latching mouth can extend into the second coupling formation. Then no distinct component is needed for providing the latching recess, but rather the latching recess can be integrated advantageously into the second coupling formation.

An opposite component edge of the second coupling formation and/or a component edge of the second coupling formation which in the second configuration of the rod assembly during a movement of the second coupling formation leads relative to the first rod in the direction from the longitudinal end-proximal position towards the longitudinal end-distal position, can exhibit a recess which preferably is so dimensioned that the latching projection can enter it and exit from it, without effecting a latching engagement with the second coupling formation. By means of this recess, in the second configuration of the rod assembly the range of relative movement of the second coupling formation and the first rod along the first axis can be lengthened despite the arrangement of a latching projection in the relative movement path of the second coupling formation.

In order to avoid undesirable excessive component weakening due to recesses in materials, the latching projection can be configured at the material-poorer component out of the second coupling formation and first rod. This is normally the second coupling formation. Consequently, in this case preferably the first rod exhibits the latching recess.

In order to ensure an orderly relative movement between the first and second rod, the second coupling formation preferably exhibits a guiding formation which in the second operating position is in guiding engagement with a guiding counter-formation of the first rod, in order to guide a movement of the second rod relative to the first rod along the first longitudinal axis. This expressly does not mean that the guiding formation is only in the second operating position of the second coupling formation in guiding engagement with the guiding counter-formation. This can also be the case in other operating positions of the second coupling formation. The guiding formation of the second coupling formation comprises preferably at least one lateral edge, preferably two opposite parallel lateral edges of a preferably plate-shaped component or component section of the second coupling formation. The preferably plate-shaped component or the preferably plate-shaped component section, respectively, can exhibit the aforementioned latching mouth and/or the aforementioned recess.

A preferred embodiment of the guiding counter-formation comprises at least one, preferably two rail-like projections parallel to the first longitudinal axis and to one another at the first rod, as already described at the beginning. As likewise described at the beginning, the parallel rail-like projections preferably form between them a groove extending along the first longitudinal axis, preferably in parallel to the latter, into which at least one section of the second coupling formation can slide in the second operating position.

Further preferably, the first rod too, as already expounded at the beginning, exhibits a fork section gripping the second rod, where the second rod is situated between the two fork limbs. The fork section preferably reaches up to a longitudinal end of the first rod.

Preferably, each fork limb exhibits the guiding counter-formation and the inhibiting counter-formation.

The longitudinal end of the first rod mentioned at the beginning, to which the end positions of the displaceability of the second rod relative to the first rod along the first longitudinal axis refer, is preferably the longitudinal end of the first rod nearest to the coupling point of the first and second rod.

In addition, a shaft of the second coupling formation preferably penetrates through the second rod. Thereby, the shaft and consequently the second coupling formation are arranged at the second rod. Likewise, the shaft of the second coupling formation penetrates through a penetrating hole in the first rod extending along the first longitudinal axis, preferably in parallel to the first longitudinal axis, preferably in each fork limb of the fork section. The shaft is then part of the guiding formation and the at least one penetrating hole is part of the guiding counter-formation.

In order to make sure that the inhibiting formation and the inhibiting counter-formation can arrive at a desired operative engagement, for instance at the aforementioned overcomeable latching engagement, according to a preferred development the inhibiting counter-formation is configured in a longitudinal extension region of the guiding counter-formation proceeding along the first longitudinal axis. Thereby the inhibiting formation and the inhibiting counter-formation can be securely guided into an operative engagement with one another. The guiding counter-formation extends preferably along the first longitudinal axis on both sides over and beyond the inhibiting counter-formation.

In order to form the rod assembly with the smallest possible number of components, the inhibiting counter-formation is preferably configured in the guiding counter-formation. To this end, the inhibiting counter-formation is preferably the latching recess. Especially preferably, the guiding counter-formation comprises the at least one rail-like projection, preferably the two parallel rail-like projections, which preferably exhibit the latching recesses. The latching recesses can be configured as simple material removals in the at least one rail-like projection. In the especially preferred embodiment with two rail-like projections parallel to one another, preferably one part-latching recess is configured in each of the flanks of the rail-like projections facing towards one another. The inhibiting counter-formation, in particular as a latching projection formed by at least one, optionally exactly one, spring pin, can be configured and/or arranged between the two rail-like projections parallel to one another, preferably at a distance from them. Thus the guiding counter-formation remains unencumbered by material removal or by the attachment of a latching projection to it and can fulfill its guiding function especially accurately.

This applies preferably to each fork limb of the aforementioned fork section.

For the avoidance of undesirable notch effects, the at least one latching recess is preferably formed concavely without kinks. A kink here is deemed to be a curvature with a radius of curvature of less than 1 mm.

In order that immediately after overcoming the latching engagement through faulty operation of the rod assembly in its third configuration which is assigned to the third operating position the first and the second rod move relative to one another in a controlled fashion, preferably the guiding formation and the guiding counter-formation are in guiding engagement with one another in the third operating position also. Especially preferably, the lateral edges of the second coupling formation are in guiding engagement with the rail-like projections, in particular with their flanks that face towards one another.

Preferably the guiding counter-formation, especially preferably the at least one rail-like projection, proceeds along the first longitudinal axis on both sides over and beyond the inhibiting counter-formation. Thereby, there is securely avoided an undesirable operating position in which the latching projection abuts against a longitudinal end of the guiding counter-formation, in particular of the at least one rail-like projection, or this longitudinal end engages from behind in some way a further latching device. This is preferably that longitudinal end which is opposite to the longitudinal end of the guiding formation, in particular of the at least one rail-like projection, which preferably forms the abutment counter-formation.

In principle it can suffice that the first and the second rod are only arranged displaceable relative to one another in a translatory manner along the first longitudinal axis. However, precisely for the preferred utilization of the rod assembly described above in a three-point hitch, preferably the first and the second rod are connected with one another pivotably about a swivel axis. Then the angle enclosed between the first and the second rod is variable. The swivel axis proceeds both transversely to the first longitudinal axis and transversely to the second longitudinal axis.

In order to be able to displace the second coupling formation between the first, the second, and the third operating position in the smallest possible movement space, the second coupling formation is preferably adjustable between the first, the second, and the third operating position by means of rotation about an axis of rotation. Preferably the swivel axis is the axis of rotation here.

In this case of the rotatability of the second coupling formation, the second coupling formation is preferably articulated pivotably about the swivel axis at the second rod both relative to the first rod and relative to the second rod, especially preferably by means of the connecting shaft.

For an advantageous introduction of an external force into the second coupling formation, the second coupling formation is preferably configured at least in the second and/or third operating position mirror-symmetrically with respect to a symmetry plane orthogonal to the aforementioned connecting shaft. Additionally preferably, at least in the second and/or the third operating position the second coupling formation is mirror-symmetrical with respect to an axis of symmetry which is parallel or coplanar to a plane spanned through a central axis of the aforementioned connecting shaft and the first longitudinal axis.

The second coupling formation preferably comprises at least one plate-shaped component, from which the connecting shaft protrudes. Especially preferably, the connecting shaft connects two essentially identical plate-shaped components. The at least one plate-shaped component, preferably both plate-shaped components, is or are, as the case may be, further preferably the aforementioned spring carrier of the latching projection configured as a spring or, as already described above, carrier or carriers respectively of the latching recess. In a preferred configuration, the at least one longitudinal end of a flat spring contributing to forming the latching projection can be clamped or forged or cast in the plate-shaped component.

In the preferred utilization of the rod assembly described above in a three-point hitch, the first rod is a lifting rod of a three-point hitch and the second rod is a lower link of the three-point hitch.

The present application likewise concerns a trailer system for an agricultural machine with a rod assembly, as described and advantageously developed above. As already mentioned several times, the trailer system is preferably a three-point hitch for an agricultural machine. In a normal operational arrangement of the three-point hitch on an agricultural machine, preferably the first configuration is the lowest position of the lower link already described above and is the third configuration of the top position of the lower link relative to the lifting rod described above.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A schematic side view of a three-point hitch as preferred utilization of a rod assembly of a first embodiment of the present application,

FIG. 2 A schematic side view of the rod assembly of FIG. 1 in the first configuration of the rod assembly described above,

FIG. 3 A schematic side view of the rod assembly of FIGS. 1 and 2 in the second configuration of the rod assembly,

FIG. 4 A schematic side view of the rod assembly of FIG. 1 to 3 in the third configuration of the rod assembly,

FIG. 5 A schematic side view corresponding to the view of FIG. 2 of a rod assembly of a second embodiment in the first configuration of the rod assembly,

FIG. 6 A schematic side view corresponding to the view of FIG. 3 of the rod assembly of FIG. 5 in the second configuration of the rod assembly,

FIG. 7 A schematic side view corresponding to the view of FIG. 4 of the rod assembly of FIGS. 5 and 6 in the third configuration of the rod assembly, and

FIG. 8 An enlarged schematic side view of the coupling arrangement of FIG. 7.

The drawings are not to scale and are merely of a schematic nature.

### DESCRIPTION OF PREFERRED EMBODIMENTS

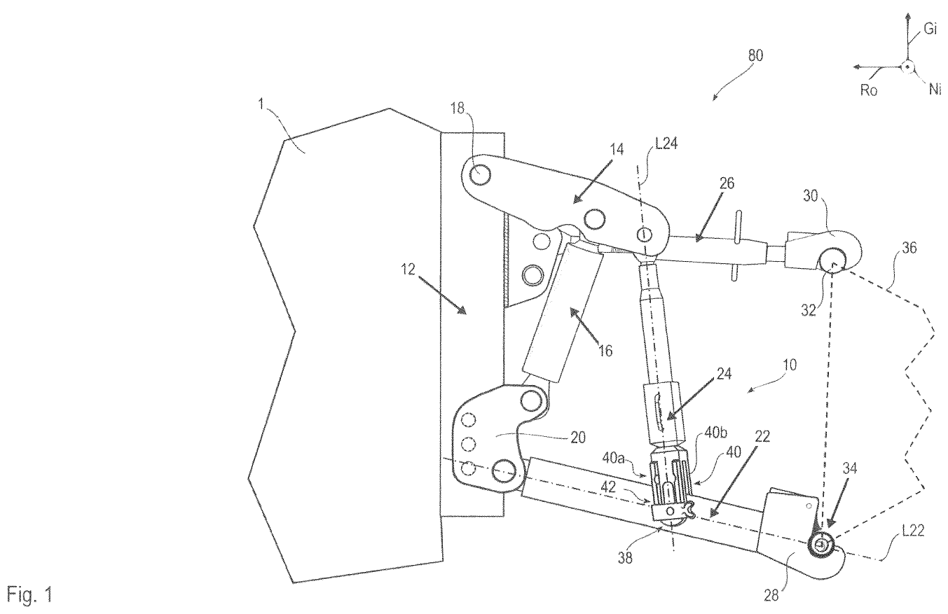

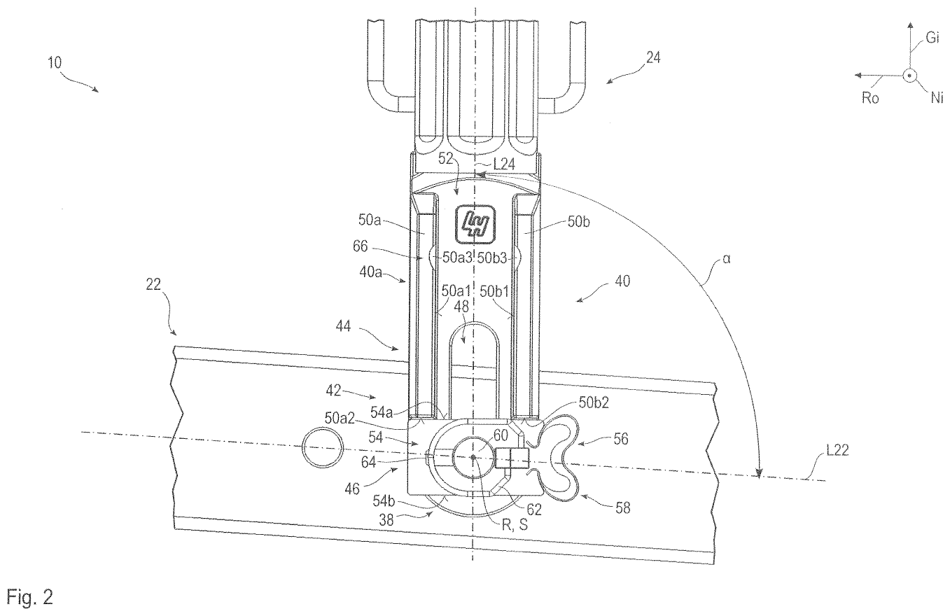

Referring now to the drawings wherein the showings are for the purpose of illustrating preferred and alternative embodiments of the invention only and not for the purpose of limiting the same, in FIG. 1 a preferred trailer system in the form of a three-point hitch 80 is arranged at a merely schematically indicated tractor 1. The three-point hitch 80 is arranged at the tail of the tractor 1. The three-point hitch 80 comprises a first embodiment of a rod assembly 10 described in further detail in conjunction with FIGS. 2 to 4. FIG. 1 is intended to depict merely in principle a three-point hitch which is known per se to ensure common understanding.

A Cartesian trihedron in the top righthand corner of FIGS. 1 to 4 indicates the coordinate system of tractor 1 for better orientation. An arrow Ro proceeding in the longitudinal direction of the tractor and pointing in the forward travel direction indicates the roll axis of tractor 1. ‘Gi’ indicates the yaw axis of the tractor 1, where the arrow of the yaw axis Gi points away from the ground on which the tractor 1 is standing. ‘Ni’ indicates the pitch axis which proceeds in the transverse direction of the tractor in accordance with the righthand rule.

The three-point hitch 80 is attached to the tail of tractor 1 by means of a base 12. A lifting arm 14 is articulated in the upper region of the base 12. The lifting arm 14 is pivotable about its articulation point 18 at the base 12 via a lifting actuator 16, for instance a hydraulic piston-cylinder arrangement.

In the depicted example, the lifting actuator 16 is articulated in a base-firm manner at its lower longitudinal end via a base-firm auxiliary carrier 20 and is articulated at its upper longitudinal end at the lifting arm 14.

In the depicted example, there is in addition a lower link 22 articulated at the base-firm auxiliary carrier 20. A lifting rod 24 connects the lower link 22 with the lifting arm 14. In this manner the lower link 22 is pivotable through the lifting actuator 16.

An upper link 26 is also articulated in a base-firm manner, which completes the three-point hitch 80.

At the base-distal longitudinal ends of the lower link 22 and of the upper link 26 there are arranged connecting hooks 28 and 30 respectively, in the hook mouths of which in a manner which is known per se ball connectors 32 and 34 respectively can be accommodated detachably at the tractor 1 for attaching a work tool 36 carrying the ball connectors 32, 34 and indicated in FIG. 1 only by a dashed line.

For spatial adjustment of the connecting hooks 28 and 30, for instance for adaptation to different work tools, individual rods and links can be configured length-variably. In the depicted embodiment example, the upper link 26 and the lifting rod 24 are length-variable, in particular by means of a screw thread.

The lifting rod 24 is a first rod of the rod assembly 10 in terms of the descriptive introduction. It extends along a virtual first longitudinal axis L24 marked by a dot-dashed line. The lower link 22 is a second rod of the rod assembly 10 in terms of the descriptive introduction. It extends along a virtual second longitudinal axis L22 marked by a dot-dashed line.

The lifting rod 24 exhibits at its longitudinal end 38 nearer to the lower link 22 a fork section 40, between whose fork limbs 40a and 40b a section of the lower link 22 is accommodated. The lower link 22 is connected with the lifting rod 24, in particular with the fork section 40, by means of a coupling arrangement 42. The fork section 40 and the coupling arrangement 42 are configured mirror-symmetrically with respect to a plane which proceeds centrally through the gap space between the fork limbs 40a and 40b.

In FIGS. 2 to 4, the fork section 40 of the lifting rod 24 and the lower link 22 articulated thereon are depicted in three different configurations. The configuration of FIG. 2 corresponds to the configuration of FIG. 1. This is the first configuration mentioned in the descriptive introduction.

The following description of the fork limb 40a facing towards the observer in FIGS. 2 to 4 applies under the aforementioned mirror-symmetry condition for a symmetry plane parallel to the respective drawing plane of FIGS. 2 to 4 lying behind the fork limb 40a in the same manner to the fork limb 40b and the sections of the coupling arrangement 42 interacting with same.

The coupling arrangement 42 exhibits a first coupling formation 44 configured and arranged at the lifting rod 24 and a second coupling formation 46 arranged at the lower link 22.

In the depicted embodiment example, the first coupling formation 44 is configured completely integrally with the lifting rod 24, in particular with its fork section 40. The first coupling formation 44 comprises a penetrating hole 48 and two rail-like projections 50a and 50b which protrude against the plane of the penetrating hole 48. The rail-like projections 50a and 50b, at least their flanks 50a1 and 50b1 which face towards one another, run in parallel to one another and to the first longitudinal axis L24. The two rail-like projections 50a and 50b, in particular their flanks 50a1 and 50b1 facing towards one another, therefore define between them a groove 52 extending along the first longitudinal axis L24 and parallel to this first longitudinal axis L24.

The second coupling formation 46 comprises a plate-shaped component 54 with on three sides an approximately rectangular structure. On the fourth side of the plate-shaped component 54 there is anchored in the plate-shaped component 54 a bent or curved, as the case may be, flat spring 56. The curved flat spring 56 forms a latching projection 58 which protrudes sideways over the two parallel lateral edges 54a and 54b of the rectangular structure of the plate-shaped component 54.

The essentially planar plate-shaped component 54 extends in the depicted embodiment example essentially parallel to the drawing plane of FIG. 2. A connecting shaft 60 extends orthogonally to the extension plane of the plate-shaped component 54 through the penetrating hole 48 and through a suitable opening in the lower link 22 and through the corresponding penetrating hole in the parallel fork limb 40b up to a further plate-shaped component on the side facing away from the observer of FIG. 2 corresponding to the plate-shaped component 54 within the framework of the described mirror-symmetry.

The second coupling formation 46 is arranged in FIG. 2 in its first operating position described in the descriptive introduction, which is assigned to the first configuration of the rod assembly 10 shown in in FIG. 2.

The plate-shaped component 54 is rotatable together with the connecting shaft 60 about an axis of rotation R orthogonal to the drawing plane of FIG. 2. The axis of rotation R is coaxial with a swivel axis S, about which the lower link 22 is pivotable relative to the lifting rod 24 within the limits of the construction of FIG. 1. The first longitudinal axis L24 and the second longitudinal axis L22 enclose in each of the shown three configurations a variable angle α, which is always greater than zero. The connecting shaft 60 can be connected with the plate-shaped component 54 rigidly and/or detachably.

In the first operating position and thereby in the first configuration, the lateral edge 54a of the plate-shaped component 54 of the second coupling formation 42 abuts as stop formation against short flanks 50a2 and 50b2 at the longitudinal ends of the rail-like projections 50a and 50b lying nearest to the longitudinal end 38, which act as stop counter-formation.

At the same time, the lower end of the penetrating hole 48 lying nearer to the longitudinal end 38 of the lifting rod 24 abuts against a lower section of the lateral surface of the connecting shaft 60, such that a translatory displacement of the lower link 22 relative to the lifting rod 24 is prevented by two physical abutments acting oppositely. In the first configuration, the lower link 22 can at most swivel about the swivel axis S defined by the connecting shaft 60 relative to the lifting rod 24 under variation of the angle α.

Due to the rotatability of the second coupling formation 46 about the axis of rotation R, the plate-shaped component could also be arranged rotated by 180° with respect to the depiction of FIG. 2, thus with a flat spring 56 facing to the left.

To facilitate the arrangement of the second coupling formation 46 in the first operating position, the plate-shaped component 54, which is secured detachably at the connecting shaft 60 by a pin 64 retained by a retaining spring 62, can be detached from the connecting shaft 60 and removed along the axis of rotation R from the lower link 22 and the lifting rod 24, can in the removed state be oriented in a desired manner and then brought into the first operating position shown in FIG. 2 and secured with pin 64 and retaining spring 62.

The plate-shaped component 54 and the opposite plate-shaped component described above on the other side of the lower link 22 or of the opposite fork limb 40b respectively thus retain between them with positive locking the lower link 22 and the fork section 40 of the lifting rod 24.

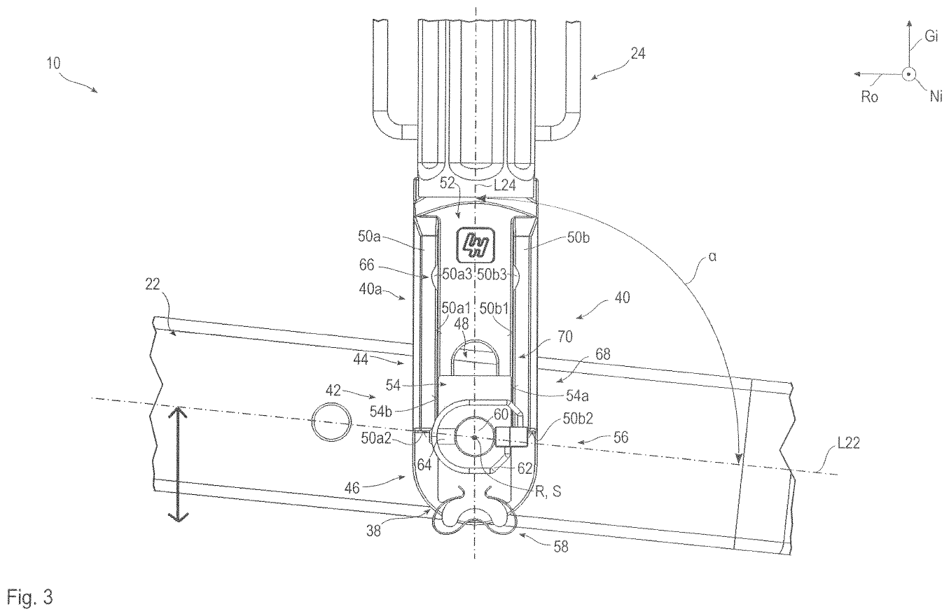

It should be added that in the flanks 50a1 and 50b1 facing towards one another of the rail-like projections 50a and 50b respectively at the same axial positions with respect to the virtual first longitudinal axis L24 there are configured part-latching recesses 50a3 and 50b3 of a latching recess 66, which in the third operating position of the second coupling formation 46 elucidated further below in connection with FIG. 3 serve for accommodating the latching projection 58.

The first configuration of the rod assembly 10 shown in FIG. 2 is chosen for instance if the work tool 36 attached to the tractor 1 by means of the three-point hitch 80 is to be moved into a particular relative height position to the tractor 1, for instance gripping into a soil on which the tractor 1 is traveling at this time.

In FIG. 3, the second coupling formation 46 is shown in its second operating position and the rod assembly 10 in its second configuration. The second coupling formation 46 is rotated by 90° clockwise relative to the first operating position of FIG. 2.

In the second operating position, the rectangular section of the plate-shaped component 54 runs in the groove 52 in such a way that the lateral edges 54a and 54b of the plate-shaped component lie directly opposite the flanks 50a1 and 50b1 respectively which face towards one another or abut against them slidingly as the case may be.

The lateral edges 54a and 54b contribute just like the connecting shaft 60 to a guiding formation 68 of the second coupling formation 46 which in guiding engagement with a guiding counter-formation 70, which comprises the rail-like projections 50a and 50b, and there in particular the flanks 50a1 and 50b1 which face towards one another, and the penetrating hole 48, guides the second coupling formation and with it the lower link 22 carrying it to movement relative to the lifting rod 24 along the virtual first longitudinal axis L24.

The second configuration of the rod assembly 10 depicted in FIG. 3 is termed a ‘floating configuration’, in which the lower link 22 with the connecting shaft 60 penetrating through it can move freely relative to the lifting rod 24 over the length of the penetrating hole 48 along the first longitudinal axis L24.

Due to the free mobility of the second coupling formation 46 and/or of the lower link 22 respectively relative to the lifting rod 24 in the degree of freedom described above, the orientation of the second coupling formation 46 in its second operating position is important, in contrast with the first operating position. The latching projection 58 is so oriented in the second operating position that it cannot get into the latching recess 66, in particular so that it does not even run in the groove 52.

As can moreover be discerned in FIG. 3, the first coupling formation 44 is formed in such a way that it is mirror-symmetrical with respect to a symmetry plane spanned by the first longitudinal axis L24 and the swivel axis S. Likewise, the second coupling formation 46 is configured mirror-symmetrically with the exception of the pin 64 and the retaining spring 62 in addition to the already described mirror symmetry with respect to a further mirror-symmetry plane orthogonal to the first mirror-symmetry plane. In the second operating position of FIG. 3, this further mirror-symmetry plane is spanned by the first longitudinal axis L24 and by the axis of rotation R. Since the swivel axis S and the axis of rotation R are coaxial, the two last mentioned symmetry planes of the first and second coupling formation 44 and 46 respectively are identical in the second and also in the third operating position.

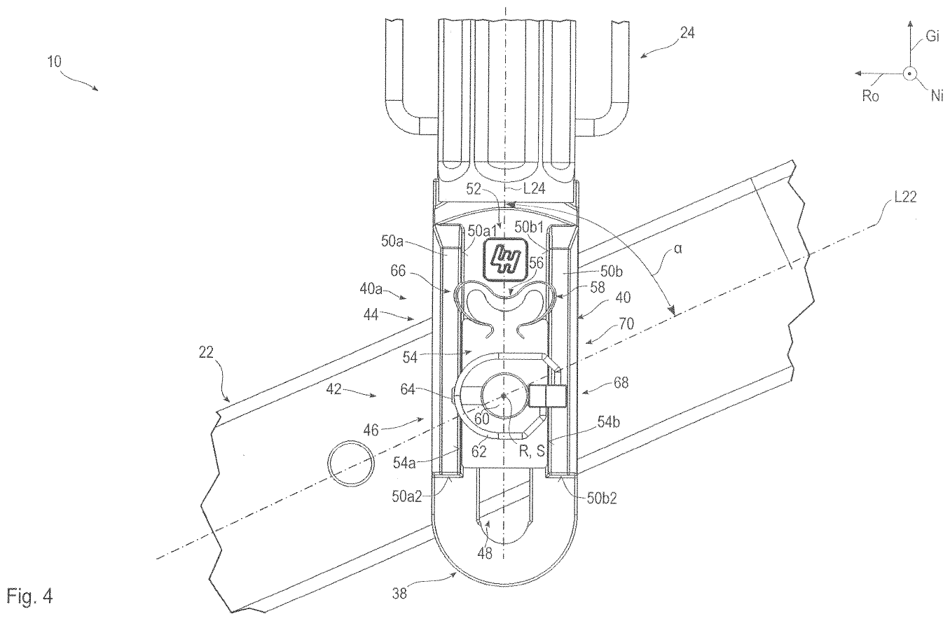

In FIG. 4, the rod assembly 10 is shown in its third configuration in which the second coupling formation 46 is in its third operating position. Compared with the second operating position, in the third operating position the second coupling formation 46 is rotated by 180° with respect to the axis of rotation R. The latching projection 58 formed by the curved flat spring 56 clamped firmly at both ends in the plate-shaped component 54 is now located at the in FIG. 3 upper longitudinal end of the plate-shaped component 54. The latching projection 58 has travelled into the latching recess 66 and meshes with it physically, where advantageously with its meshing contour section it clings in a planar manner against the wall of the latching recess 66 and preferably abuts against the latter. In the first embodiment shown in FIGS. 1 to 4, the latching recess 66 forms the inhibiting formation mentioned in the descriptive introduction and the latching projection 58 forms the inhibiting counter-formation cooperating with the latter.

As in the first configuration, in the third configuration too a lateral surface section of the connecting shaft 60 abuts against the now upper or located further away from the longitudinal end 38 of the lifting rod 24, respectively, longitudinal end of the penetrating hole 48. Whereas in the first configuration the abutting lateral surface section is a circumferential section of the lateral surface of the connecting shaft 60 facing towards the longitudinal end 38, in the third configuration this is a circumferential section facing away from the longitudinal end 38. Through the interaction of abutting circumferential section of the connecting shaft 60 and latching engagement between latching projection 58 and latching recess 66, the lifting rod 24 and the lower link 22 are, as formerly in the first configuration, also in the third configuration and thereby in the third operating position of the second coupling formation 46 are connected backlash-free with one another with regard to a translatory movement along the virtual first longitudinal axis L24. As the sole movement degree of freedom, in the third configuration too the lower link 22 can as in the first configuration pivot relative to the lifting rod 24 only about the swivel axis S.

Whereas in the first configuration the lower link 22 is fixed at the lifting rod 24 in a nearest possible relative position to the longitudinal end 38, in the third configuration the lower link 22 is situated at the lifting rod 24 at the furthest away possible relative position from the longitudinal end 38.

The third configuration is chosen, for example, when the tractor 1 has to maneuver during a strongly decreased collision risk due to the three-point hitch 80 attached at its tail.

The latching engagement established between the latching projection 58 and the latching recess 66 is overcomeable due to the configuration of the latching projection 58 as an elastically deformable spring component. This means that the latching engagement can be disengaged non-destructively by a sufficiently great force acting on the lower link 22. Here, due to the degree of freedom predetermined by the guiding formation 68 and the guiding counter-formation 70, only the force component along the translatory movement degree of freedom through the guiding formation 68 and the guiding counter-formation 70 is decisive. Since the connecting shaft 60 abuts against the upper or distal to the longitudinal end 38 longitudinal end of the penetrating hole 48, respectively, there exists in the depicted embodiment example a movement degree of freedom of the lower link 22 and of the second coupling formation 46 attached to it only starting from the third configuration in the direction towards the longitudinal end 38 proximal to the coupling point of lower link 22 and lifting rod 24.

Such a force component occurs for example if unintentionally or unwittingly and against the actual proper purpose, in the third configuration a load is attached to the connecting hooks 28 and 30 of the three-point hitch 80.

In an advantageous manner, such an inappropriate load on the lower link 22 exerted in the third configuration leads to overcoming the overcomeable latching engagement. The third configuration is indeed relinquished, but the rod assembly 10 remains undamaged overall. A deformation of the latching projection 58 arising through overcoming the latching engagement is merely temporary and reversible.

In an advantageous manner, in the third embodiment too the guiding formation 68 and the guiding counter-formation 70 are in guiding engagement with one another, such that on overcoming the latching engagement there follows a defined movement of the lower link 22 relative to the lifting rod 24 and of the second coupling formation 46 relative to the first coupling formation 44. This increases in an advantageous manner the operational safety of the rod assembly 10 and with it of the three-point hitch 80.

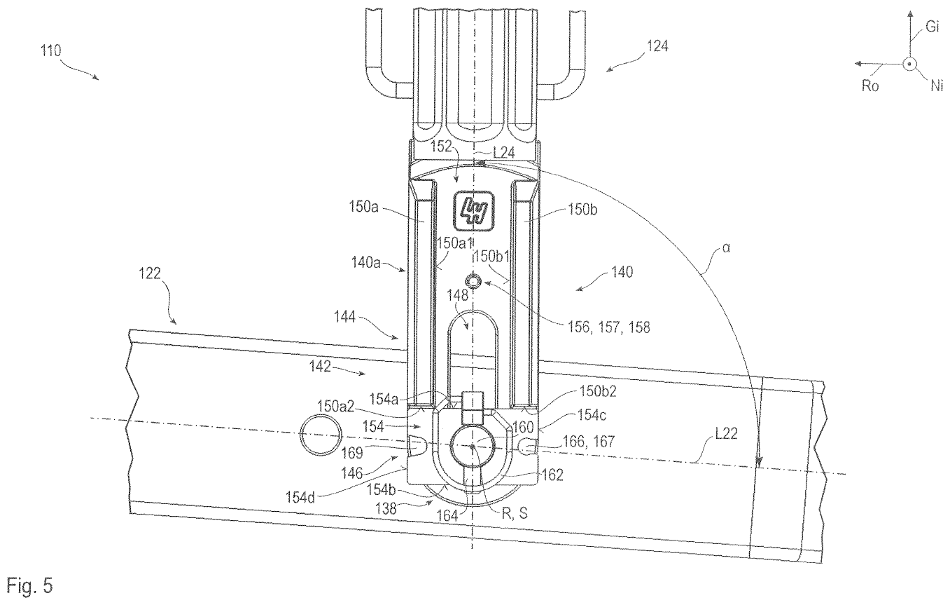

In FIGS. 5 to 8 there is depicted a second embodiment of the rod assembly of the present invention. In FIGS. 5 to 8, identical and functionally identical components and component sections of the second embodiment are labelled with the same reference symbols as in FIGS. 1 to 4 for the first embodiment, but increased numerically by 100. The second embodiment shall be described below only in so far as it differs from the first embodiment, to the description of which reference shall be otherwise made also for elucidating the second embodiment.

In FIG. 5 there is shown the second embodiment of the rod assembly 110, as before in FIG. 2 the first embodiment, in its first configuration. This means that the second coupling formation 146 is in its first operating position. A component edge 154a abuts physically against the short flanks 150a2 and 150b2 of the rail-like projections 150a and 150b. Likewise, a section of the outer circumferential surface of the connecting shaft 160 facing towards the longitudinal end 138 abuts against the longitudinal end-proximal curved bounding edge of the long hole 148, such that the lower link 122 is essentially fixed in a translatory manner relative to the lifting rod 124 and can merely rotate about the swivel axis S which is coaxial with the axis of rotation R. The axis of rotation R and the swivel axis S are orthogonal to the drawing plane of FIGS. 2 to 5.

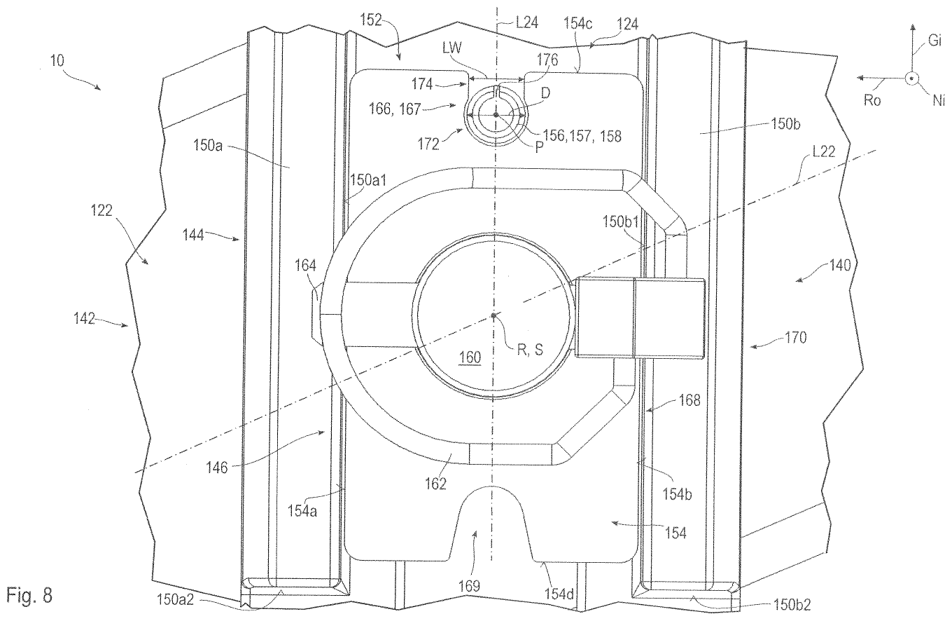

The essential difference between the first and the second embodiment consists in that the latching projection 158 is configured as a spring pin 157 and is fixed at the lifting rod 124. The spring pin 157 is configured as a spring 156, since it can be elastically deformed under a decrease of the gap width of its longitudinal gap 176 (see FIG. 8). Further details in this regard shall be elucidated further below in connection with FIG. 8, which shows a latching engagement of the second coupling formation 146, in the depicted embodiment example of its plate-shaped component 154, with the latching projection 158.

The essentially, i.e. for example with the exception of possibly chamfered longitudinal ends, cylindrical spring pin is arranged in the groove 152 between the rail-like projections 150a and 150b, preferably in the transverse center of the groove 152, and protrudes in the depicted embodiment example orthogonally to the drawing plane of FIGS. 5 to 8, that is to say also orthogonally to the groove base of the groove 152, out from the groove base. The groove 152 is therefore a spring carrier of the spring pin 157 which forms a spring component.

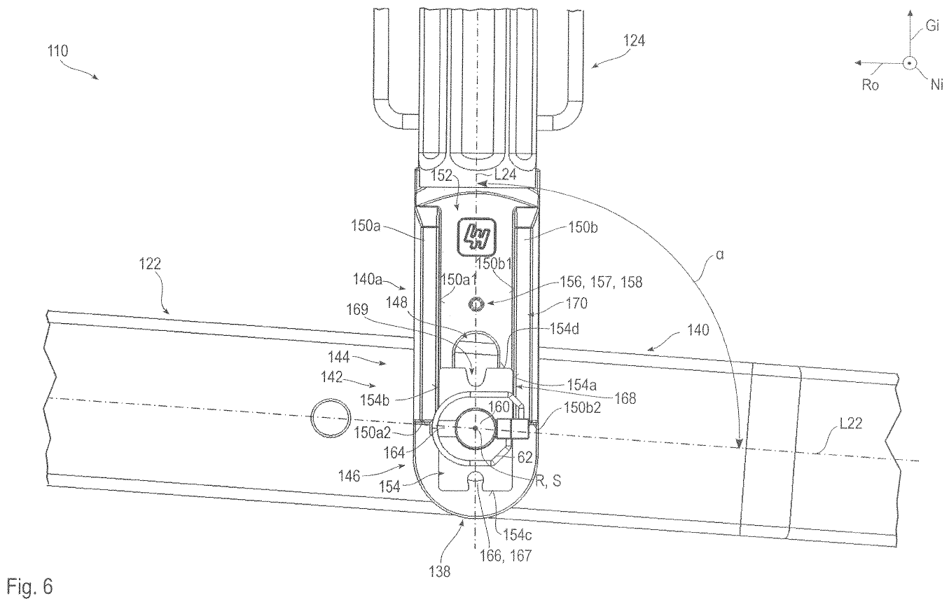

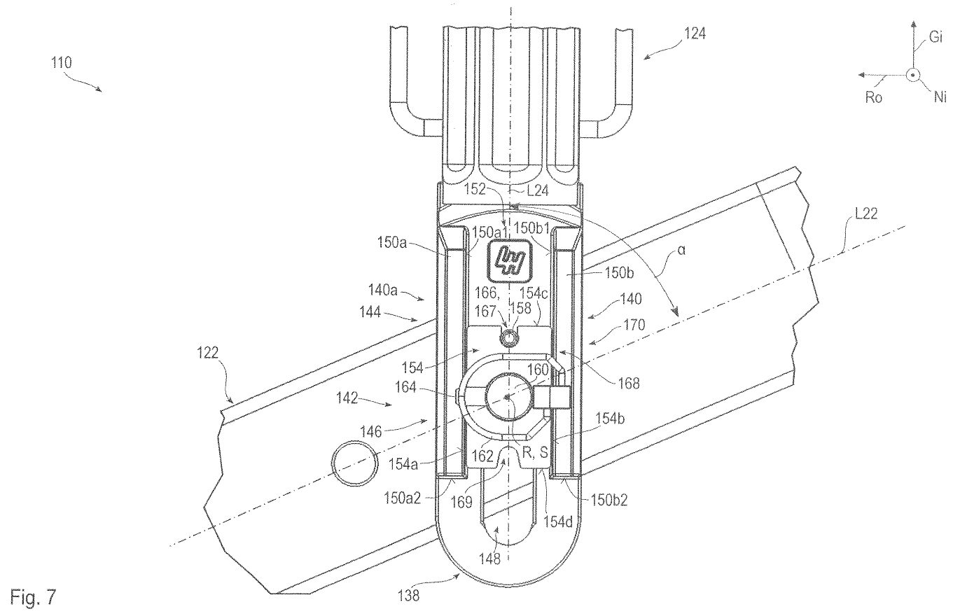

In order to establish an overcomeable latching engagement, the second coupling formation 146, in particular its plate-shaped component 154, exhibits at a transverse edge 154c which connects the longitudinal edges 154a and 154b which form the guiding formation 168 (see FIGS. 6, 7 und 8), the latching recess 166 which cooperates with the latching projection 158. The latching recess 166 is configured as a latching mouth 167, which likewise shall be elucidated in further detail in connection with FIG. 8.

At the opposite transverse edge 154d, the second coupling formation 146, in particular its plate-shaped component 154, exhibits a recess 169 into which the latching projection 158, due to its dimensions, can enter and exit from, without thereby effecting a latching engagement with the second coupling formation 146.

According to the second embodiment, the inhibiting formation mentioned in the descriptive introduction is formed by the latching recess 166 and the inhibiting counter-formation by the latching projection 158.

In FIG. 6, the second embodiment of the rod assembly 110 is depicted in its second configuration, which again is a floating configuration as was elucidated in further detail above in connection with FIG. 3. Accordingly, the second coupling formation 146 is in its second operating position relative to the lifting rod 124.

In the second configuration of the rod assembly 110, the component edge 154d, which exhibits the recess 169, leads during a movement of the second coupling formation 146 in the direction towards the longitudinal end-proximal end position ahead of the opposite component edge 154c with the latching recess 166. Through the recess 169 in the component edge 154d, the movement path of the second coupling formation 146 and in particular of the plate-shaped component 154 can be increased relative to the lifting rod 24 along the first longitudinal axis L24, since the latching projection 158 in the form of the spring pin 157 can enter the recess 169 and only delayed by the depth of the recess 169 gets into an abutment engagement with the component edge 154d which ends the movement of the second coupling formation 146.

In FIGS. 7 and 8, the rod assembly 110 is depicted in its third configuration and accordingly the second coupling formation 146 in its third operating position. The latching recess 166 is in an overcomeable latching engagement with the latching projection 158 and thus holds the second coupling formation 142 and with it the lower link 122 fast against a translatory movement. The statements made above regarding FIG. 4 also apply to the third configuration of the second embodiment of the rod assembly 110 with the exception that the latching projection 158 is configured by a spring pin 157 at the lifting rod 124 and the latching recess 166 at the second coupling formation 146.

In FIG. 8 there is shown the pin axis P, oriented orthogonally to the drawing plane of FIG. 8, of the latching projection 158 configured as a spring pin 157.

The spring pin 157 is situated in a mouth accommodating space 172, into which it has arrived due to a movement through a narrower mouth entrance 174. The clear width LW of the mouth entrance 174 is smaller by a predetermined amount than the outer diameter D of the spring pin 157.

A slit 176 which penetrates through the spring pin 157 over its entire axial length and over its entire radial dimension with respect to the pin axis P allows elastic change in the shape of the spring pin 157 and thus a passage through the mouth entrance 174. After reaching the mouth accommodating space 172 which is wider than the mouth entrance 174, the spring pin 157 relaxes to its original shape and thus fixes the second coupling formation 146 along the first longitudinal axis L24 relative to the first lifting rod 124.

The latching engagement formed between spring pin 157 and latching recess 166 is overcomeable by a force which depends on the dimensional difference between the clear width LW and the outer diameter D, on the material of the spring pin 157, which usually is spring steel, and on the material thickness of the hollow spring pin 157. For secure producibility and overcomeability of the latching engagement between the spring pin 157 and the latching recess 166, the slit 172 is preferably arranged in the transverse center of a region traversed by the mouth entrance 174, at least in the region traversed by the mouth entrance 174.

The second embodiment with the spring pin 157 as latching projection 158 allows a very inexpensive production of rod assemblies 110 with a latchable coupling arrangement 142, since spring pins 157 are produced as standard components in large quantities with consistent properties and are available commercially in the marketplace.

Note: FIG. 1 has been prepared as a purely black and white drawing on the basis of a depiction published by Mr. Frank Bruns-Ballhausen on Wikipedia in accordance with the usage permit granted under https://commons.wikimedia.org/-wiki/File:Dreipunkt_mechanik.svg.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A rod assembly for a trailer system, where the rod assembly comprises a first rod extending along a first longitudinal axis and a second rod extending along a second longitudinal axis, where the first and the second rod are connected through a coupling arrangement, where the first and the second longitudinal axis enclose an angle, where the second rod is displaceable relative to the first rod at the point of its coupling with the first rod along the first longitudinal axis between a longitudinal end-proximal position lying nearer to a longitudinal end of the first rod and a longitudinal end-distal position lying further from the longitudinal end,
where the coupling arrangement exhibits a first coupling formation and a second coupling formation, where the first coupling formation is arranged at the first rod, where the second coupling formation is arranged at the second rod moveably both relative to the first rod and also relative to the second rod,
where the second coupling formation exhibits an abutment formation and an inhibiting formation and where the first rod exhibits an abutment counter-formation and an inhibiting counter-formation,
where the second coupling formation can be brought relative to the first rod into a first operating position in which the abutment formation abuts against the abutment counter-formation and thereby inhibits a movement of the second rod relative to the first rod from the longitudinal end-proximal position towards the longitudinal end-distal position,
where the second coupling formation can be brought relative to the first rod into a second operating position different from the first operating position, in which a movement of the second rod relative to the first rod along the first longitudinal axis is allowed, and
where the second coupling formation can be brought relative to the first rod into a third operating position different from the first and the second operating position, in which the inhibiting formation interacts with the inhibiting counter-formation and thereby inhibits a movement of the second rod relative to the first rod from the longitudinal end-distal position towards the longitudinal end-proximal position,
where one formation out of inhibiting formation and inhibiting counter-formation exhibits a latching projection and the respective other formation out of inhibiting formation and inhibiting counter-formation a latching recess, where in the third operating position the inhibiting formation and the inhibiting counter-formation are, disengageable against a pre-tensioning, in an overcomeable latching engagement.

17. The rod assembly for a trailer system according to claim 16, wherein the latching projection and/or the latching recess is and/or are, as the case may be, configured displaceable against spring pre-tensioning and/or elastically deformable for overcoming a latching engagement established between the latching projection and the latching recess.

18. The rod assembly for a trailer system according to claim 17, wherein the latching projection comprises a spring, in particular a curved flat spring or leaf spring or wire spring clamped on one side or both sides to a spring carrier.

19. The rod assembly for a trailer system according to claim 16, wherein the latching projection is configured mirror-symmetrically.

20. The rod assembly for a trailer system according to claim 16, wherein the second coupling formation exhibits the latching projection and the first rod the latching recess or that the second coupling formation exhibits the latching recess and the first rod the latching projection.

21. The rod assembly for a trailer system according to claim 16, wherein the second coupling formation exhibits a guiding formation which in the second operating position is in guiding engagement with a guiding counter-formation of the first rod in order to guide a movement of the second rod relative to the first rod along the first longitudinal axis.

22. The rod assembly for a trailer system according to claim 21, wherein the inhibiting counter-formation is configured in a longitudinal extension region of the guiding counter-formation proceeding along the first longitudinal axis and/or that the inhibiting counter-formation is configured in the guiding counter-formation.

23. The rod assembly for a trailer system according to claim 22, wherein also in the third operating position the guiding formation and the guiding counter-formation are in guiding engagement with one another.

24. The rod assembly for a trailer system according to claim 21, wherein also in the third operating position the guiding formation and the guiding counter-formation are in guiding engagement with one another.

25. The rod assembly for a trailer system according to claim 22, wherein the guiding counter-formation proceeds along the first longitudinal axis on both sides over and beyond the inhibiting counter-formation.

26. The rod assembly for a trailer system according to claim 23, wherein the guiding counter-formation proceeds along the first longitudinal axis on both sides over and beyond the inhibiting counter-formation.

27. The rod assembly for a trailer system according to claim 16, wherein the first and the second rod are connected with one another pivotably about a swivel axis, such that the angle enclosed between the first and the second rod is variable, where the swivel axis proceeds both transversely to the first longitudinal axis and transversely to the second longitudinal axis.

28. The rod assembly for a trailer system according to claim 16, wherein the second coupling formation is adjustable through rotation about an axis of rotation between the first, the second, and the third operating position.

29. The rod assembly for a trailer system according to claim 27, wherein the second coupling formation is adjustable through rotation about an axis of rotation between the first, the second, and the third operating position and wherein the swivel axis is the axis of rotation.

30. The rod assembly for a trailer system according to claim 16, wherein the first rod is a lifting rod of a three-point hitch and that the second rod is a lower link of the three-point hitch.

31. A trailer system for an agricultural machine with a rod assembly according to claim 16.

32. The trailer system according to claim 31, wherein the trailer system is a three-point hitch for an agricultural machine, wherein the first rod is a lifting rod of the three-point hitch and that the second rod is a lower link of the three-point hitch.
